(19) United States
(12) Patent Application Publication
(10) Pub. No.: US 2004/0219045 A1
(43) Pub. Date: Nov. 4, 2004

(54) Enclosed mechanical booster

(76) Inventors: Masashi Yoshimura, Kumage-gun (JP); Akito Fukuda, Kumage-gun (JP); Kiyoshi Fukuhara, Kumage-gun (JP)

Correspondence Address: McDermott, Will & Emery, 600 13th Street, NW, Washington, DC, 20005-3096, US

(21) Appl. No.: 10/474,795

(22) PCT Filed: Dec. 14, 2001
(86) PCT No.: PCT/JP01/10986

(30) Foreign Application Priority Data
Oct. 23, 2001 (JP) 2001-325177

(51) Int. Cl. F01C 1/30; F03C 2/00

(52) U.S. Cl. 418/3

(57) ABSTRACT

To improve reliability of a shaft sealing portion of a mechanical booster and simplify the structure, in a mechanical booster 1 having a motor 3 in tight contact with to a mechanical booster body 2 and rotating the shaft part 4, inserting a metal cylinder into a gap between a stator on a rotary shaft of the motor 3 and a fixed coil on the outside for partitioning stator area and a fixed coil area by the cylinder, supporting the both end of the rotary shaft of the motor 3 by bearings sealed with lubricant, and inserting a bearing fitting portion of a motor cover 30 into inside of the cylinder, the motor is sealed with a seal ring. The cylinder is made of stainless steel. A jacket water cooler is provided in the motor cover 30 around at area close to outside. The shaft part 4 of the mechanical booster body 2 is supported by bearings sealed with lubricant.

### BACKGROUND OF THE INVENTION

1. Field of the Invention

This invention relates to an enclosed mechanical booster structured by combining a mechanical booster body by means of a Roots impeller or the like and a motor for driving.

2. Description of the Related Art

FIGS. 4 and 5 show a usual mechanical booster.

A mechanical booster 61 is structured by combining a mechanical booster body 62 and a motor 63. The mechanical booster 61 is used as a forepump corresponding to a main pump, such as a water-sealed vacuum pump, Roots multistage dry-sealed vacuum pump or a screw vacuum pump, for increasing pumping speed in high vacuum range as shown in FIG. 6B or decreasing ultimate vacuum pressure lower than that of the main pump 80. In FIGS. 4 and 5, a pair of rotors or impellers in the mechanical booster body 62 are not shown.

Generally, a pump at vacuum side is called as a forepump and a pump at atmospheric air side is called as a main pump. The mechanical booster 61 is used for the forepump. When absorbing air from atmospheric air, the main pump 80 (FIG. 6A) starts to absorb air and a vacuum switch 81 (FIG. 6A) is activated at predetermined vacuum pressure level to start the mechanical booster 61. In FIG. 6B, a horizontal axis corresponds to vacuum pressure P, a vertical axis to pumping speed S, and Pu shows an ultimate pressure and ATM shows an atmospheric pressure.

The mechanical booster 61 is provided at an end portion of a rotor to be connected with the motor 63 or a main shaft 64 of the impeller with a mechanical seal 65, so as to prevent from air leakage through a shaft seal portion for increasing pumping speed in high vacuum range or decreasing ultimate vacuum pressure.

The main shaft 64 is connected with a drive shaft 66 of the motor 63 by a spider 17 and a coupling 18. A countershaft 67 is disposed in parallel to the main shaft 64. The both end portions of each shaft 64, 67 are respectively supported rotatably by a bearing 68 and respective end portions, far from the motor 63, of the shafts are connected by timing gears 22 with each other to rotate freely in an opposite direction to each other. Each shaft 64, 67 is provided at an opposite side of the end portion thereof from the bearing 68 with a ring-shape lip seal 8. The lip seal 8 is held in a holder 10. The holder 10 is fixed in a partition wall 7 or 28. The partition walls 7 or 28 is fixed tightly to a drive-side cover 85 (bearing cover) or a gearbox 21 to place an O-ring 12 between a casing 6. The casing 6 receives a rotor or an impeller (not shown) inside thereof and has an inlet 69 and an outlet 70 at a top side or a bottom side thereof.

The main shaft 64 is provided at an end portion side from the bearing 68 of a motor side with an oil seal 71. A rotating ring 72 is fixed close to the end portion of the main shaft from the oil seal 71 on the main shaft 64. A metal fixed ring 73 is disposed close to the end portion from the rotating ring 72 so as to contact slidably with the rotating ring 72. The fixed ring 73 is fixed on a holder 74. The holder 74 is fixed on a vertical partition wall 76 of the drive-side cover 85 to place an O-ring 75 therebetween. The cover 85 is fixed on a flange of the motor by screw fastening to have an O-ring therebetween. A mechanical seal 65 is structured by the rotating ring 72 and the fixed ring 73. The oil seal 71 and the mechanical seal 65 partition an area of the bearing 68 and an area of the motor 63.

Lubricating oil 24 is filled respectively into the drive-side cover 85 and the gearbox 21. A splasher 25 is fixed respectively on a top end of the countershaft 67 in the cover 85 and on the timing gear 22. A sliding surface of the mechanical seal 65, seal 71 and bearings 68 are lubricated by oil splashed by the splasher 25.

Amount of oil is monitored with a level gauge 77 (FIG. 4). Each room 78, 26 of the drive-side cover 85 and the gearbox 21 is connected to each other with an equalizing pipe 27 located at a top area. Each bottom area of the drive-side cover 85 and the gearbox 21 is connected to each other with a communicating tube (oil passage) 79 (FIG. 4) to prevent from oil-level change by oil leakage or oil mist transfer through the equalizing pipe 27 (FIG. 5).

The motor 63 is a not-sealed totally-enclosed fan cooled motor and may have a structure to blow cooling air on an outer side of the motor.

Objects to be Solved

In the general mechanical booster 61 mentioned above, the shaft is sealed by the mechanical seal 65. A sliding surface of the mechanical seal 65 is lubricated by oil in the cover 85 with the splasher 25 to maintain the surface in condition of boundary lubrication for good sealing performance. Since the mechanical booster 61 is used as a forepump as mentioned above, the room 78 of the drive-side cover 85 in which the mechanical seal 65 is located may be in vacuum condition in use. Therefore, oil film is not formed easily on the sliding surface and oil film on the sliding surface may be broken to roughen the sliding surface and increase friction drag. Thereby, unusual sound, air pumping and oil leakage through the cover 85 may be caused easily. When oil leakage occurred, the motor 63 may be damaged. When air is leaked through the mechanical seal 65, oil in the cover 85 may enter into the casing 6 together with the air pumped to the impeller area or rotor area so that disassembling and cleaning of the mechanical booster 61 is troublesome. The mechanical seal and various seal member having complex structure are required for sealing means so that the structure may become complex and be oversized.

To overcome the above drawback, one object of this invention is to provide a mechanical booster having high reliability, simple structured shaft seal portion and compact structure by solving above drawback caused by the mechanical seal.

### SUMMARY OF THE INVENTION

How to Attain the Object

In order to attain the objects, an enclosed mechanical booster according to claim 1 of the present invention, which has a motor joined tightly to a mechanical booster body to rotate a shaft portion of the mechanical booster body, includes a metal cylinder being inserted into a gap between a stator at a rotating shaft side of the motor and an outer fixed coil for partitioning stator area and fixed coil area, sealed bearings with fluorine grease having vapor pressure as same as pressure of high vacuum area supporting both ends of a rotating shaft of the motor, and a sealing for sealing the motor so as to insert a bearing fitting portion of a motor cover into an inside of the cylinder.

According to the above structure, an inside of the motor is maintained airtight by the cylinder and the both sealed bearings. Thereby, a room of motor fitting side of the mechanical booster body is maintained airtight so that a mechanical seal for partitioning a usual motor and the mechanical booster body is not required. Thus, drawbacks caused by the mechanical seal are solved. In contrast with the mechanical seal, the cylinder for sealing performs static sealing so that abrasion is not occurred and reliability of sealing is enhanced. Not only the mechanical seal but also lubricating oil, a splasher and a partition wall for supporting the mechanical seal are not required.

The enclosed mechanical booster according to claim 2 is specified by that, in the enclosed mechanical booster according to claim 1, the cylinder is made of stainless steel.

According to the above structure, cylinder made of stainless steel may not be corroded so that the fixed coil to be affected easily by corrosive gas is protected from the corrosive gas by partitioning with the cylinder.

The enclosed mechanical booster according to claim 3 is specified by that, in the enclosed mechanical booster according to claim 1 or 2, a jacket water cooler is provided in the motor cover around at area close to outside.

According to the above structure, the motor is cooled effectively and the jacket water cooler partitions the inside of the motor from atmospheric air so that air tightness is enhanced.

The enclosed mechanical booster according to claim 4 is specified by that, in the enclosed mechanical booster according to claim 1, 2 or 3, a drive-side of a shaft of the mechanical booster body is supported by a bearing sealed with lubricant having low saturated vapor pressure, such as fluorine grease.

According to the above structure, oil lubricating the bearing supporting the shaft from outside is not required so that drawbacks caused by using oil, such as oil leakage, is solved.

### BRIEF DESCRIPTION OF THE DRAWINGS

FIG. 1 is a cross sectional view of an embodiment of an enclosed mechanical booster according to this invention;

FIG. 2 is a longitudinal section of the enclosed mechanical booster in FIG. 1;

FIG. 3 is a half section (side view which upper half is sectioned) of a motor of the enclosed mechanical booster;

FIG. 4 is a cross sectional view of a usual mechanical booster;

FIG. 5 is a longitudinal section of the usual mechanical booster;

FIG. 6A is a piping diagram, showing connection between a forepump and a main pump; and

FIG. 6B is a graph, showing relation between pumping speed and vacuum pressure of the both pumps.

### DESCRIPTION OF THE BEST MODE

An embodiment according to this invention will now be described with reference to figures.

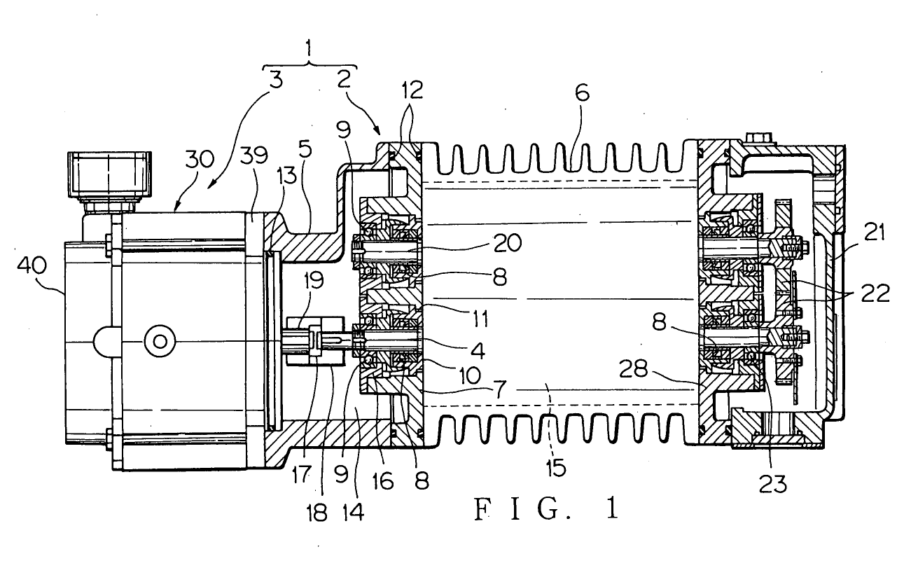

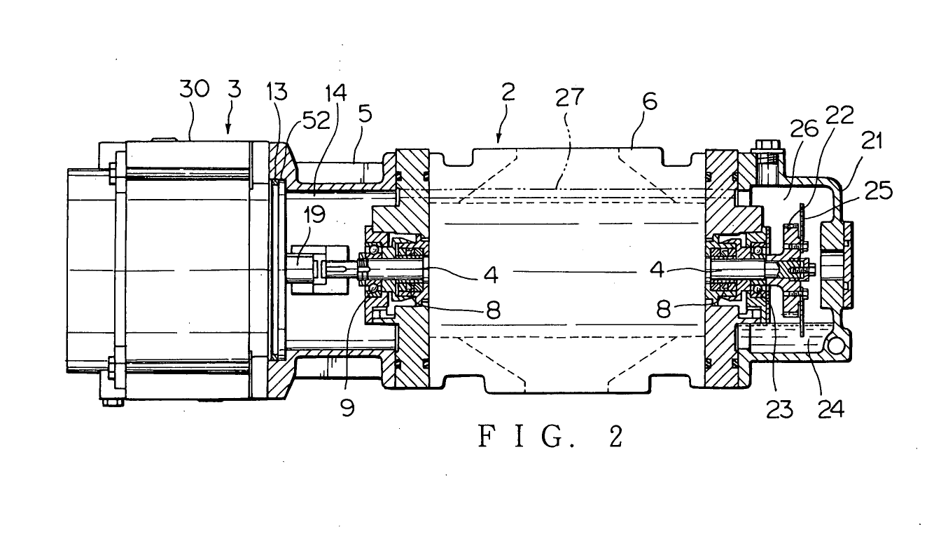

FIGS. 1 and 2 show one embodiment of an enclosed mechanical booster according to this invention.

A mechanical booster 1 includes a mechanical booster body 2 and a motor 3 fixed tightly on the mechanical booster 2. The mechanical booster 1 is specified to enclose the motor 3 for driving a main shaft 4 instead of a usual mechanical seal at the mean shaft 4 of the mechanical booster body 2.

A structure of the mechanical booster 1 is almost same as the usual mechanical booster excluding the motor 3 and a drive-side part (close to the motor 3) of the mechanical booster 2 so that components same as the usual one are given the same mark and detailed description will be omitted.

Oil in a cover, a splasher for splashing oil, a level gauge for checking oil, a communicating tube for passing oil and a partition wall in the cover other than the mechanical seal of the usual mechanical booster body are eliminated. Corresponding to elimination of the mechanical seal, a room as an oil sump and a splasher, a cover 5 at drive-side is miniaturized and compacted, and the main shaft 4 is shortened. Drawbacks caused by the usual mechanical seal are solved.

An end portion of the main shaft 4 projecting from a casing 6 is sealed by a lip seal (sealing member) 8 in a partition wall 7 and supported rotatably at near end side thereof from the lip seal 8 by a bearing 9. The lip seal 8 is fixed in a holder 10 and the holder 10 is fixed air-tightly through an O-ring (seal ring) 11 on the partition wall 7. The partition wall 7 is clamped and fixed through an O-ring (seal ring) 12 between end surfaces of the casing 6 and the drive-side cover 5. The cover 5 is fixed through an O-ring (seal ring) 13 at a flange thereof on the motor 3. A space 14 of the cover 5 is sealed air-tightly from outside and also from a space 15 of the casing 6 by the lip seal 8, the O-ring 12 and the double-side sealed bearing 9.

The bearing 9 at drive-side (close to the motor) is double-side seal type to be filled with fluorine grease as lubricant. Openings at the both sides of balls in the bearing are sealed by ring seals (not shown). Thereby, usual oil for lubricating a bearing is not required in the drive-side cover 5. The bearing 9 is fixed in a holder 16 and the holder 16 is fixed on the partition wall 7. The main shaft 4 at near end side from the bearing 9 is connected with a drive shaft 19 of the motor 3 by a coupling (shaft coupling) 18 including a spider 17.

A countershaft 20 is sealed in the partition wall 7 by the lip seal 8 and supported rotatably by the bearing 9 similarly as the main shaft 4. Corresponding to elimination of the usual splasher at an end of the countershaft 20, the countershaft 20 is shortened.

A structure in an opposite side (side cover) 21 against the motor 3 is same as the usual one. The main shaft 4 and the countershaft 20 are engaged by a timing gear 22 and impellers or rotors (not shown) of the both shafts are rotatable in opposite directions to each other. The both shafts 4, 20 in a gearbox 21 are sealed respectively at far side from an end thereof by the lip seal 8 and supported respectively at near side to the end thereof by a bearing 23. The lip seal 8 and the bearing 23 are fixed through each holder on a partition wall 28.

Oil 24 is poured into the gear box 21 and can be supplied on the bearing 23 and the lip seal 8 by a splasher 25 fixed on the timing gear 22. The space 14 of the drive-side cover 5 and a space 26 of the gearbox 21 are communicated by an equalizing hole 27 (FIG. 2) at upper area.

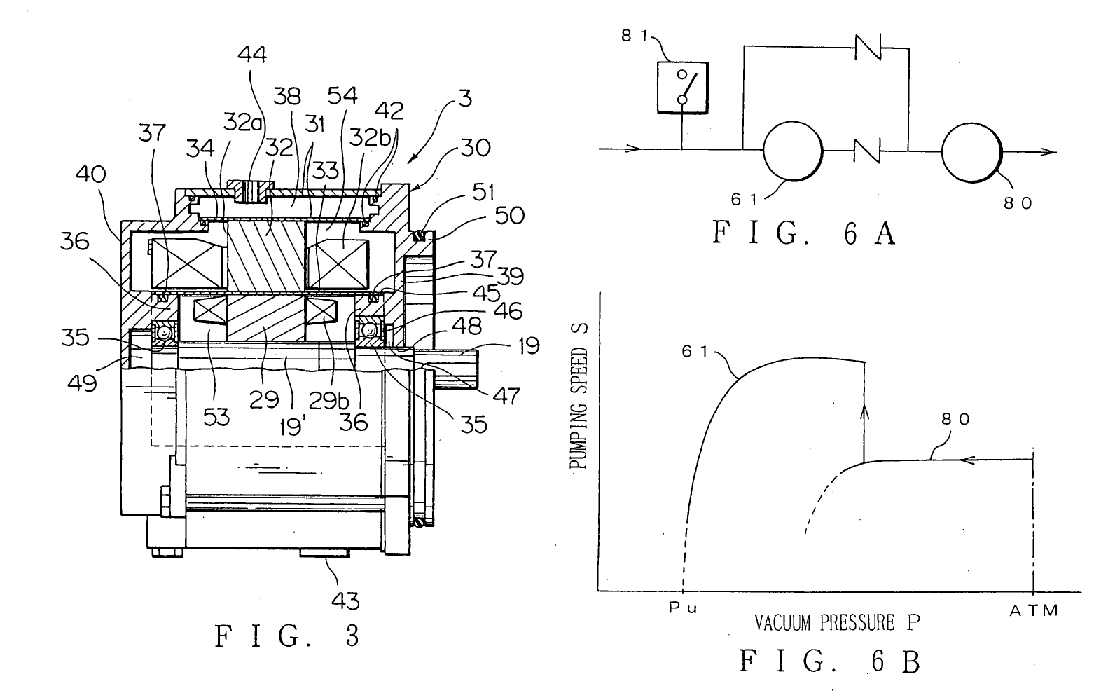

FIG. 3 is a half section of the motor 3. Means for sealing the motor 3 is inserting a stainless steel cylinder 34 of approximately 0.3 mm thickness into a cylindrical narrow gap 33 between a stator (iron core) 29 fixed on a rotating shaft (drive shaft) 19′ and a cylindrical fixed coil 32 fixed on an outer cylindrical portion 31 of a motor cover 30, supporting rotatably both ends of the rotating shaft 19′ respectively by double-side sealed bearings 35, inserting each cylindrical bearing fitting portion 36 of the motor cover 30 into inside of the cylinder 34 so as to position and fix the cylinder 34, and placing an O-ring (seal ring) 37 between an outer surface of the bearing fitting portion 36 and an inner surface of the cylinder 34. The O-ring 37 is fitted in a ring groove formed on the outer surface of the bearing fitting portion 36.

The motor 3 is alternating current type. The outer fixed coil 32 includes a core portion 32a in the center thereof and coil portions 32b at both ends thereof. The core portion 32a is fixed on a cover outer cylindrical portion 31. Inserting the cylinder 34 into the gap 33 between the core portion 32a and the stator 29, the both coil portions 32b and both coil portions 29b of the stator 29 are partitioned. The stator 29 rotates integrally with the rotating shaft 19′ and the fixed coil 32 is positioned unmovably at outside of the stator 29. The cylinder 34 is not contacted with at least the stator 29. The cylinder 34 is made of stainless steel having good ductility to be formed easily into thin plate and non-magnetic characteristics so that a gap between the fixed coil 32 and the stator 29 can be small and power performance of the motor 3 is not affected.

The outer cylindrical portion 31 of the motor cover 30 has a jacket water cooler 38 at a middle position of thickness thereof and the outer cylindrical portion 31 is joined air-tightly through each O-ring (seal ring) 42 with side covers 39 and 40 at the both end thereof. The outer cylindrical portion 31 has a cooling water inlet 43 at a bottom side thereof and a cooling water outlet 44 at a top side of thereof. Sealing cylinder 34 is inserted between the fixed coil 32 and the stator 29 before one of the side covers 39 and 40 is mounted. The side covers 39, 40 mounting bearing 35 and O-ring 37 are assembled with the rotating shaft 19′, the cylinder 34 and the outer cylindrical portion 31. Respective outer surfaces of the ring-shaped bearing fitting portions 36 at both ends are inserted into the inner surfaces at the both ends of the cylinder 34. The both end surfaces of the cylinder 34 abut respectively on step portions 45 at outer surfaces of the both bearing fitting portions 36 so as to be positioned without a rattling of an axial direction.

The bearing 35 is filled with fluorine grease as lubricant and is double-side sealed type which both sides of bearing balls are covered by ring sealing members 46. An inner surface of each bearing 35 is fitted air-tightly on an outer surface of the rotating shaft 19′ and an outer surface of each bearing 35 is fitted air-tightly on an inner surface of the bearing fitting portion 36 of the each side cover 39, 40. Each bearing fitting portion 36 is a wall portion projecting cylindrically from an inner surface of the side cover 39 or 40 to have a concave portion for fitting a bearing inside thereof. A concave portion 47 at drive-side is coaxially continuous to a rotating shaft through hole 48 and an end portion of the rotating shaft 19′ projects toward outside as the drive shaft 19 connected with the main shaft 4 of the mechanical booster body 2 (FIG. 1). A concave portion 49 at the opposite side against the drive-side is sealed with the side cover 40.

A ring wall 50 is formed at radially outer side of neck portion of projecting drive shaft 19 by projecting from the side cover 39. The ring wall 50 is provided around on an outer surface with a ring groove in which an O-ring 51 is mounted fitly. The ring wall 50 is fitted into a ring concave portion 52 at an inner side of the drive-side cover 5 of the mechanical booster body 2, as shown in FIG. 1.

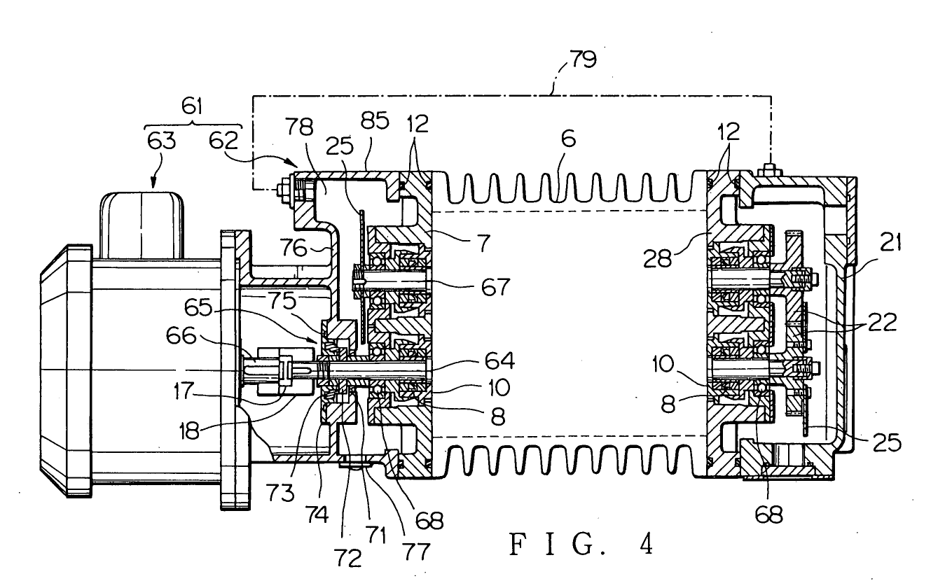

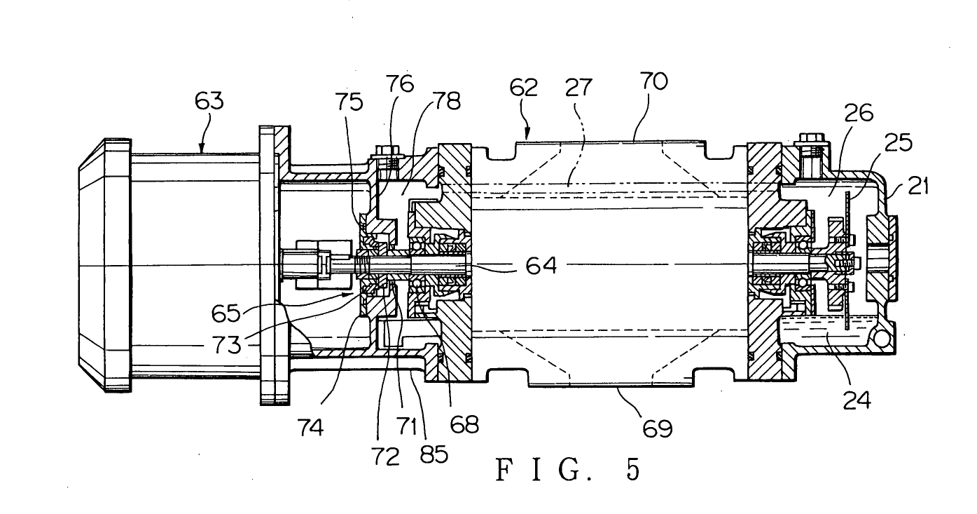

A space 53 at the rotating shaft 19′ side (stator 29 side) is partitioned air-tightly from a space 54 at the outer fixed coil 32 side by the cylinder 34 of the motor 3 in FIG. 3. The space 53 at the rotating shaft 19′ side is partitioned air-tightly from a space 14 (FIG. 2) in the drive-side cover 5 by the double-side seal bearing 35. Especially, outside (atmospheric air) of the motor 3 and the space 53 of the rotating shaft side are accurately partitioned air-tightly by the cylinder 34. Thereby, the usual mechanical seal and the usual partition wall in the drive-side cover 5 in FIG. 5 are not required, and the space 14 in the cover and the outside (atmospheric air) of the motor are securely partitioned air-tightly.

According to the mechanical booster 1 mentioned above, usual mechanical seal, oil in the drive-side cover, a splasher, a level gauge, a communicating tube and a partition wall are not required so that the structure can be compacted, lightened and cost-reduced. Drawbacks of mechanical sound, leakage and drawing of atmospheric air caused by the usual mechanical seal are solved and reliability of the mechanical booster 1 is improved.

### Possibility of Applications in Industries

According to claim 1 of the present invention as mentioned above, a usual mechanical seal for partitioning a motor and a mechanical booster body is not required. Thereby, drawbacks of strange sound, drawing of atmospheric air, oil leakage and disassembling/cleaning a mechanical booster by oil suction caused by worn-out of the usual mechanical seal are solved and reliability of the mechanical booster 1 is improved. Especially, there is no wearing in sealing cylinder differently from the mechanical seal so that the reliability of sealing is improved. Oil for lubrication, a splasher and a partition wall for supporting the mechanical seal other than the mechanical seal are not required so that the structure can be simplified and compacted, and the cost is reduced.

According to claim 2 of the present invention, the cylinder is prevented from oxidation, and air-tightness of the motor is maintained in a long term so that the reliability of sealing is improved.

According to claim 3 of the present invention, the motor is cooled effectively, and the mechanical booster can be rotated in high speed and driven for long time, and air-tightness of inside area of the motor and reliability of sealing are enhanced by the jacket water cooler.

According to claim 4 of the present invention, oil lubricating for the bearing at drive-side (motor side) of the mechanical booster body is not required so that drawbacks caused by using oil such as oil leakage and oil suction are solved. Thereby, reliability of the mechanical booster is improved, and the structure is compacted and the cost is reduced by means of eliminating parts such as oil and the splasher.

What is claimed is:

1. An enclosed mechanical booster, which has a motor joined tightly to a mechanical booster body to rotate a shaft portion of the mechanical booster body, comprising:
a metal cylinder being inserted into a gap between a stator at a rotating shaft side of the motor and an outer fixed coil for partitioning stator area and fixed coil area;
bearings sealed with lubricant having low vapor pressure supporting both ends of a rotating shaft of the motor; and
a seal ring for sealing the motor so as to insert a bearing fitting portion of a motor cover into an inside of the cylinder.

2. The enclosed mechanical booster according to claim 1, wherein the cylinder is made of stainless steel.

3. The enclosed mechanical booster according to claim 1 or 2, wherein a jacket water cooler is provided in the motor cover around at area close to outside.

4. The enclosed mechanical booster according to claim 1, 2 or 3, wherein a drive-side of a shaft of the mechanical booster body is supported by a bearing sealed with lubricant having low saturated vapor pressure.
